(19) United States
(12) Patent Application Publication
(10) Pub. No.: US 2014/0043378 A1
(43) Pub. Date: Feb. 13, 2014

(54) ELECTROPHORETIC DISPLAY DEVICE

(71) Applicants: Hiroshi Inoue, Osaka-shi (JP); Tomochika Yoshitsugi, Osaka-shi (JP)

(72) Inventors: Hiroshi Inoue, Osaka-shi (JP); Tomochika Yoshitsugi, Osaka-shi (JP)

(73) Assignee: SAKURA COLOR PRODUCTS CORPORATION, Osaka-shi (JP)

(21) Appl. No.: 14/113,311

(22) PCT Filed: Apr. 23, 2012
(86) PCT No.: PCT/JP2012/060823

§ 371 Date: Oct. 22, 2013

(30) Foreign Application Priority Data
Apr. 26, 2011 (JP) 2011-098519

(51) Int. Cl. G09G 3/34

(52) U.S. Cl. CPC G09G 3/344
USPC 345/690; 345/77

(57) ABSTRACT

Provided is an electrophoretic display device that can be more easily produced. The electrophoretic display device with pixels comprises a substrate, a plurality of pixel electrode units formed for each pixel on the substrate, a voltage applying means for applying a voltage to each pixel electrode unit, and a charged particle-containing chamber containing colored charged particles and disposed so as to extend across the plurality of pixel electrode units; each of the pixel electrode units having a first electrode disposed in the center of a pixel, and a second electrode disposed on the peripheral edge of the pixel.

### TECHNICAL FIELD

The present invention relates to an electrophoretic display device.

### BACKGROUND ART

In recent years, the electrophoretic display device (so-called “electronic paper”), which displays an image by the electrophoresis of charged particles, has seen widespread use as a next-generation display device. This electrophoretic display device has, for example, a structure in which microcapsules corresponding in number to the number of pixels are disposed between electrodes provided on the upper and lower sides, as proposed in PTL 1. Each microcapsule contains positively charged white particles and negatively charged black particles. In this electrophoretic display device, when a voltage is applied to the electrodes so that the upper electrode is negative and the lower electrode is positive, the white charged particles move to the upper end of the microcapsules, while the black charged particles move to the lower end thereof. Accordingly, white is observed from above the microcapsules. Conversely, when a voltage is applied to the electrodes so that the upper electrode is positive and the lower electrode is negative, the black charged particles move to the upper end of the microcapsules, while the white charged particles move to the lower end thereof. Accordingly, black is observed from above the microcapsules.

### CITATION LIST

### Patent Literature

PTL 1: JP2005-70462A

### SUMMARY OF INVENTION

### Technical Problem

However, the above-mentioned electrophoretic display device had a problem in that it required complicated production processes, including the production of a microcapsule for each pixel, and the filling of each microcapsule with charged particles.

Therefore, an object of the present invention is to provide an electrophoretic display device that can be more easily produced.

### Solution to Problem

The electrophoretic display device of the present invention was made to solve the above problem. The electrophoretic display device with pixels comprises a substrate, a plurality of pixel electrode units formed for each pixel on the substrate, a voltage applying means for applying a voltage to each pixel electrode unit, and a charged particle-containing chamber containing colored charged particles and disposed so as to extend across the plurality of pixel electrode units; each pixel electrode unit having a first electrode disposed in the center of a pixel, and a second electrode disposed on the peripheral edge of the pixel.

In the electrophoretic display device, the substrate is provided with a plurality of pixel electrode units, and the charged particle-containing chamber filled with charged particles is disposed so as to extend across the pixel electrode units. Accordingly, when a voltage is applied to each pixel electrode unit by the voltage applying means, the charged particles move across the pixel electrode units in the charged particle-containing chamber, and are collected on the first electrode or second electrode of each pixel electrode unit depending on the polarity of the charged particles and the polarity of the pixel electrode unit. Thus, a plurality of pixels can be displayed by the charged particles in the charged particle-containing chamber, and there is no need to produce a microcapsule for each pixel as before; hence, the above electrophoretic display device can be easily produced. In the “plurality of pixel electrode units formed for each pixel on the substrate” in the present invention, the first electrodes and the second electrodes may be provided on the same surface or different surfaces of the substrate. The “charged particle-containing chamber disposed so as to extend across the pixel electrode units” may be such that the charged particle-containing chamber is disposed on one surface of the substrate, or that the substrate is accommodated in the charged particle-containing chamber.

The electrophoretic display device may have a structure in which the electrophoretic display device comprises at least three layers of display units, each display unit comprising a substrate, a plurality of pixel electrode units formed on the substrate, a charged particle-containing chamber, and a voltage applying means, wherein the charged particles are colored with different colors for every charged particle-containing chamber. According to this structure, various colors can be displayed for each pixel, and a different color can be displayed by each pixel.

The electrophoretic display device may have a structure in which the first electrodes and the second electrodes are disposed on one surface of the substrate; and the voltage applying means has a first wiring formed on the other surface of the substrate and connected to each of the first electrodes via respective through-holes provided in the substrate, and a second wiring formed on the one surface of the substrate and connected to each of the second electrodes. According to this structure, the occurrence of short circuiting between the first electrodes and the second electrodes can be prevented.

The electrophoretic display device may have a structure in which the first electrodes are disposed on one surface of the substrate, while the second electrodes are disposed on the other surface of the substrate; and the voltage applying means has a first wiring formed on the one surface of the substrate and connected to each of the first electrodes, and a second wiring formed on the other surface of the substrate and connected to each of the second electrodes. According to this structure, the occurrence of short circuiting between the first electrodes and the second electrodes can also be prevented.

The electrophoretic display device may further comprise a lattice-like member that is accommodated in the charged particle-containing chamber and that extends across the plurality of pixel electrode units. According to this structure, the charged particles in the charged particle-containing chamber can be prevented from being collected on a specific pixel electrode unit.

In the electrophoretic display device, the charged particles may be negatively charged electret particles made of a material containing fluorine. According to this structure, the charged particles can be electrophoresed regularly and quickly.

### Advantageous Effects of Invention

The present invention allows an electrophoretic display device to be more easily produced.

### BRIEF DESCRIPTION OF DRAWINGS

FIG. 1 is a front cross-sectional schematic view of an electrophoretic display device according to a first embodiment of the present invention.

FIG. 2 is a plan cross-sectional schematic view of the substrate of the electrophoretic display device according to the first embodiment of the present invention.

FIG. 3 is a partially enlarged front cross-sectional view showing the action of the electrophoretic display device according to the first embodiment of the present invention.

FIG. 4 is a plan cross-sectional schematic view showing the action of the electrophoretic display device according to the first embodiment of the present invention.

FIG. 5 is a front cross-sectional schematic view of an electrophoretic display device according to a second embodiment of the present invention.

FIG. 6 is a partially enlarged front cross-sectional view showing the action of the electrophoretic display device according to the second embodiment of the present invention.

FIG. 7 is a plan view showing the arrangement of the first and second electrodes according to a modified example of the above embodiments.

### DESCRIPTION OF EMBODIMENTS

### First Embodiment

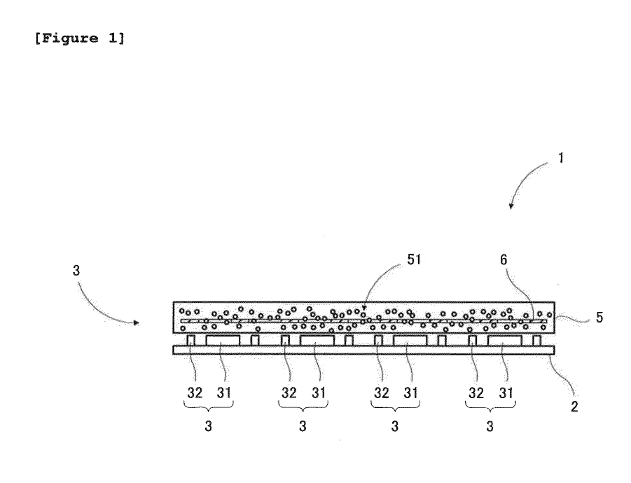

The first embodiment of the electrophoretic display device according to the present invention is described below with reference to FIGS. 1 to 4.

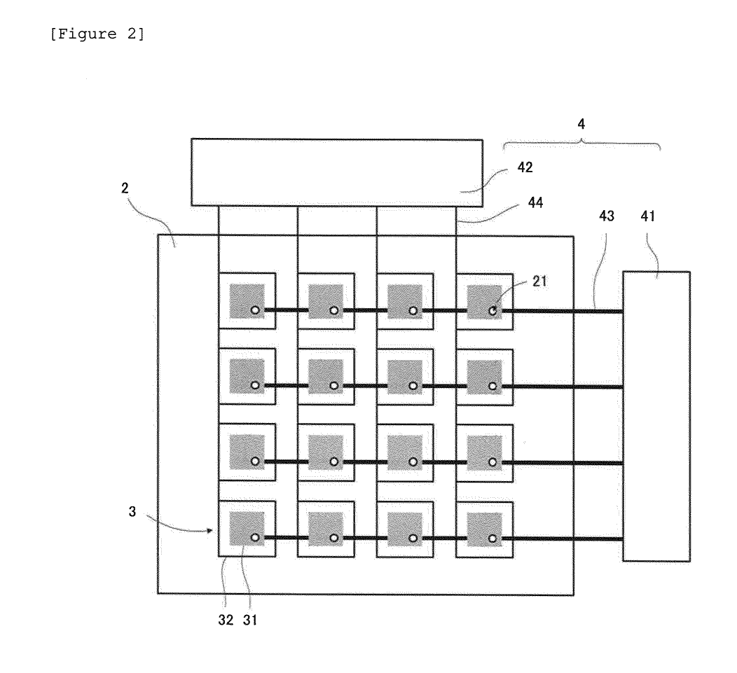

As shown in FIGS. 1 and 2, an electrophoretic display device 1 according to the first embodiment comprises a substrate 2, a plurality of pixel electrode units 3 provided on the substrate 2, a voltage applying means 4 for applying a voltage to each pixel electrode unit 3, and a charged particle-containing chamber 5 extending along the substrate 2.

The substrate 2 is made of, for example, glass or a transparent synthetic resin, such as polyethylene terephthalate. As shown in FIG. 2, the substrate 2 has a plurality of through holes 21 that are used to electrically connect the voltage applying means 4, described later, and each pixel electrode unit 3. The plurality of pixel electrode units 3 are formed on the substrate 2, and each pixel electrode unit 3 has a first electrode 31 disposed in the center of a pixel, and a second electrode 32 disposed on the peripheral edge of the pixel to surround the first electrode. The area of the second electrode 32 is not limited, but is preferably, for example, about 0.1 to 50% of the area of the first electrode 31. The first electrode 31 and the second electrode 32 can be made of, for example, a highly conductive metal, such as copper or silver, a transparent conductive resin, an ITO (indium tin oxide) film, or the like; and can be formed on the substrate 2 by printing, evaporation, plating, or other method.

The voltage applying means 4 is used to apply a voltage to each pixel electrode unit 3, and has an X-axis drive circuit 41 and a Y-axis drive circuit 42, as shown in FIG. 2. The X-axis drive circuit 41 has a plurality of X-axis electrode wires 43 (first wiring) extending therefrom. Each axis electrode wire 43 is connected to the first electrodes 31 of the pixel electrode units 3 aligned in the X-axis direction via thin-film transistors (not shown) and the through holes 21 from the bottom side of the substrate 2. The Y-axis drive circuit 42 has a plurality of Y-axis electrode wires 44 (second wiring) extended therefrom. Each Y-axis electrode wire 44 is connected to the second electrodes 32 of the pixel electrode units 3 aligned in the Y-axis direction from the top side of the substrate 2. According to this structure, when the X-axis drive circuit 41 applies a voltage to an X-axis electrode wire 43, the thin-film transistors (not shown) of all of the first electrodes 31 connected to this X-axis electrode wire 43 are turned on to apply the voltage to the first electrodes 31. When the Y-axis drive circuit 42 applies a voltage to a Y-axis electrode wire 44 in this state, an electric potential difference is generated between the first electrode 31 and the second electrode 32 in the pixel electrode unit 3 in the intersection of this Y-axis electrode wire 44 and the X-axis electrode wire 43, to which the voltage has already been applied. The electric potential difference causes charged particles 51 in the charged particle-containing chamber 5, described later, to move toward the first electrode 31 or the second electrode 32.

The charged particle-containing chamber 5 is disposed above the substrate 2 so as to extend across the pixel electrode units 3, as shown in FIG. 1. The charged particle-containing chamber 8 is filled with charged particles 51 colored with one color (e.g., white or black), together with an electrophoretic medium. The charged particle-containing chamber 8 preferably has a lattice-like member 6 for preventing the charged particles 51 from gathering in a specific area. In addition, a black plate or a white plate may be provided in the lower part of the substrate 2 so as to easily recognize the color of the charged particles 51 in the charged particle-containing chamber 8.

The material of the charged particle-containing chamber 5 is not limited insofar as it is insulating and transparent. For example, transparent synthetic resins, such as acrylic resin, PET, or glass can be used. Examples of the electrophoretic medium include air and liquid media, such as ethylene glycol (EG), propylene glycol (PG), glycerin, dimethyl silicone oil and other silicone oils, perfluoropolyether oil and other fluorine-containing oils, and petroleum oils. Silicone oils are particularly preferred among the liquid media.

The charged particles 51 are negatively charged electret particles made of a material containing fluorine. The mean particle diameter of the charged particles 51 is not limited; however, for small-sized displays, the mean particle diameter is 0.01 to 20 μm, whereas for large-sized displays, the mean particle diameter is generally 0.5 to 3 mm, and preferably 1 to 2 mm.

The charged particles 51 for small-sized displays are produced by, for example, emulsifying a fluorine-containing (non-polymerizable) compound or fluorine-containing polymerizable compound having a liquid phase under atmospheric or elevated pressure in a liquid that is incompatible with these compounds, to produce emulsified particles, and irradiating the emulsified particles, which are either in the form of a suspension or redispersed in an electrophoretic medium, with an electron ray or a radial ray. The conditions of irradiation with an electron ray or a radial ray are not limited insofar as the particles are properly processed into electret particles. For example, the irradiation may be carried out by emitting an electron ray of about 10 to 50 kGy using an electron linear accelerator. Radial ray irradiation may be performed, for example, by emitting a gamma ray of about 1 to 15 kGy. Suitable examples of the fluorine-containing compound or fluorine-containing polymerizable compound having a liquid phase under elevated pressure are those having a liquid phase at a temperature of about 0 to 100° C. and a pressure of 5 to 30 bar. When such a compound is used, the emulsified particles of the compound are produced in conditions under which the compound is in the liquid phase. When the fluorine-containing polymerizable compound is used, the emulsified particles of the compound are cured with heat, ultraviolet irradiation, or the like. When curing with heat, for example, the emulsified particles are heated at about 80° C. for about an hour. When curing with ultraviolet irradiation, the emulsified particles undergo 1 to 2 J/cm² ultraviolet irradiation having a wavelength of 365 nm.

Examples of the fluorine-containing compound include various known fluorine-containing resins, fluorine-containing oils, fluorine-containing adhesives, and the like. Examples of fluorine-containing resins include tetrafluoroethylene resin and the like, such as polytetrafluoroethylene (PTFE) represented by FR₁C═R₁R₂, wherein R₁=F or H, and R₂=F, H, Cl or other arbitrary elements. Examples of fluorine-containing oils include perfluoropolyether oil, chlorotrifluoroethylene oligomer, and the like, such as perfluoropolyether oil (product name: “DEMNUM,” Daikin Industries, Ltd.) and chlorotrifluoroethylene oligomer (product name: “DAIFLOIL,” Daikin Industries, Ltd.). Examples of fluorine-containing adhesives include ultraviolet-curable fluorinated epoxy adhesives, and the like, such as “OPTODYNE” (product name: Daikin Industries, Ltd.).

Examples of the fluorine-containing polymerizable compound include various known fluorine-containing elastomers, fluorine-containing varnishes, polymerizable fluorocarbon resins, and the like. Examples of fluorine-containing elastomers used as the fluorine-containing polymerizable compound include straight-chain fluoropolyether compounds, such as “SIFEL3590-N,” “SIFEL2610,” and “SIFEL8470” (all are products of Shin-Etsu Chemical Co., Ltd.). Examples of fluorine-containing varnishes include tetrafluoride ethylene/vinyl monomer copolymer (product name: “Zeffle,” Daikin Industries, Ltd.) and the like. Examples of polymerizable fluorocarbon resins include polymerizable amorphous fluorocarbon resin (product name: “CYTOP,” Asahi Glass Co., Ltd.), and the like.

The liquid that is incompatible with the fluorine-containing compound and fluorine-containing polymerizable compound is not limited. Examples thereof include water, ethylene glycol (EG), propylene glycol (PG), glycerin, and silicone oil. A suitable liquid is selected from these liquids depending on the fluorine-containing compound or fluorine-containing polymerizable compound to be used. Further, a so-called electrophoretic medium may be used as the liquid that is incompatible with the fluorine-containing compound and fluorine-containing polymerizable compound. Examples of the electrophoretic medium include ethylene glycol (EG), propylene glycol (PG), glycerin, dimethyl silicone oil and other silicone oils, perfluoropolyether oil and other fluorine-containing oils, and petroleum oils.

Examples of the emulsifier used for emulsification include polyvinyl alcohol and ethylene maleic anhydride. The content of the emulsifier in the liquid that is incompatible with the fluorine-containing compound and fluorine-containing polymerizable compound is preferably about 1 to 10 wt %. Emulsified particles may be prepared by placing those components into a known mixing device, such as a stirrer, mixer, homogenizer, or the like, and evenly mixing them. In this case, mixing is preferably performed under heat.

For larger-sized displays, the charged particles 51 are produced, for example, by irradiating a fluorine-containing resin sheet with an electron ray or a radial ray to convert the sheet into an electret sheet, and grinding the electret sheet by a known plastic film-grinding machine or the like. The conditions of irradiation with an electron ray or a radial ray are not limited insofar as the fluorine-containing resin sheet is processed into an electret sheet; however, irradiation is preferably carried out by applying an electron ray or a radial ray simultaneously and uniformly to the entire sheet from a perpendicular direction. Irradiation with an electron ray or a radial ray may be performed, for example, by emitting an electron ray of about 10 to 2,000 kGy or a gamma ray of about 1 to 15 kGy using an electron linear accelerator.

The fluorine-containing resin sheet is not limited insofar as it functions as an electron trap. Examples thereof include a tetrafluoroethylene-hexafluoropropylene copolymer sheet (FEP), a tetrafluoroethylene-perfluoroalkyl vinyl ether copolymer sheet (PFA), a polytetrafluoroethylene sheet (PTFE), a tetrafluoroethylene-ethylene copolymer sheet (ETFE), a polyvinylidene fluoride sheet (PVDF), a polychlorotrifluoroethylene sheet (PCTFE), a chlorotrifluoroethylene-ethylene copolymer sheet (ECTFE), and the like. Among these fluorine-containing resin sheets, at least one of the FEP sheet, PFA sheet, and PTFE sheet is particularly preferred.

The above-described fluorine-containing compound, fluorine-containing polymerizable compound, and fluorine-containing resin sheet contain a pigment in advance. The pigment is not limited. Examples thereof include azo pigments, such as β-naphthol-based pigments, naphthol AS-based pigments, acetoacetic acid-based pigments, aryl amide-based pigments, pyrazolone-based pigments, acetoacetic acid aryl amide-based pigments, pyrazolone-based pigments, β-naphthol-based pigments, β-oxynaphthoic acid-based pigments (BON acid-based pigments), naphthol AS-based pigments, acetoacetic acid allylide-based pigments, and the like. Other examples include polycyclic pigments, such as phthalocyanine-based pigments, anthraquinone-based (threne) pigments, perylene-based or perinone-based pigments, indigo-based or thioindigo-based pigments, quinacridone-based pigments, dioxazine-based pigments, isoindolinone-based pigments, quinophthalone-based pigments, metal complex pigments, methine-based or azo methine-based pigments, diketopyrrolopyrrole-based pigments, and the like. Still other examples include azine pigments, daylight fluorescent pigments (resin dye solid solutions), hollow resin pigments, nitroso pigments, nitro pigments, natural pigments, and the like. The pigment may be selected from commercial products, such as Symuler Fast Yellow 4GO, Fastogen Super Magenta RG, Fastogen Blue TGR (DIC Corporation), Fuji Fast Red 7R3300E, Fuji Fast Carmine 527 (Fuji Shikiso K.K.), and the like. The pigment particle diameter is preferably about 0.02 to 20 μm, and more preferably about 0.02 to 3 μm.

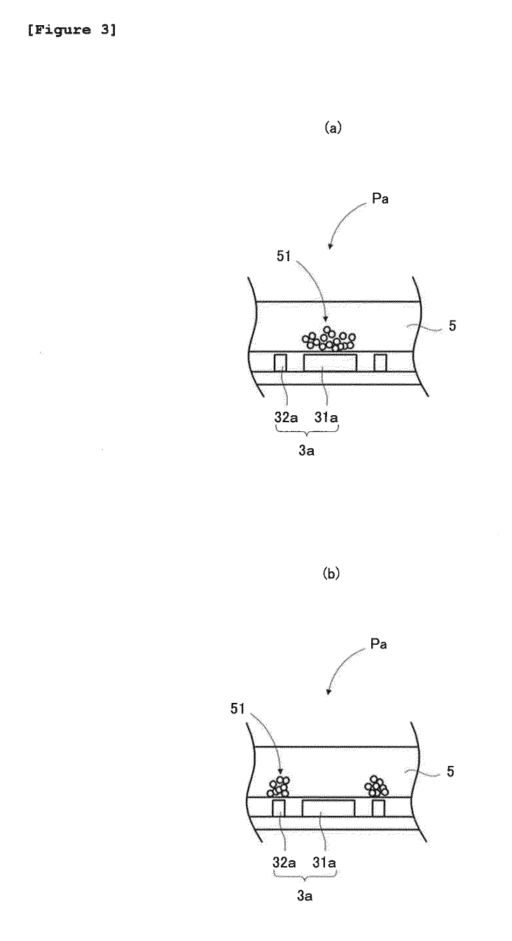

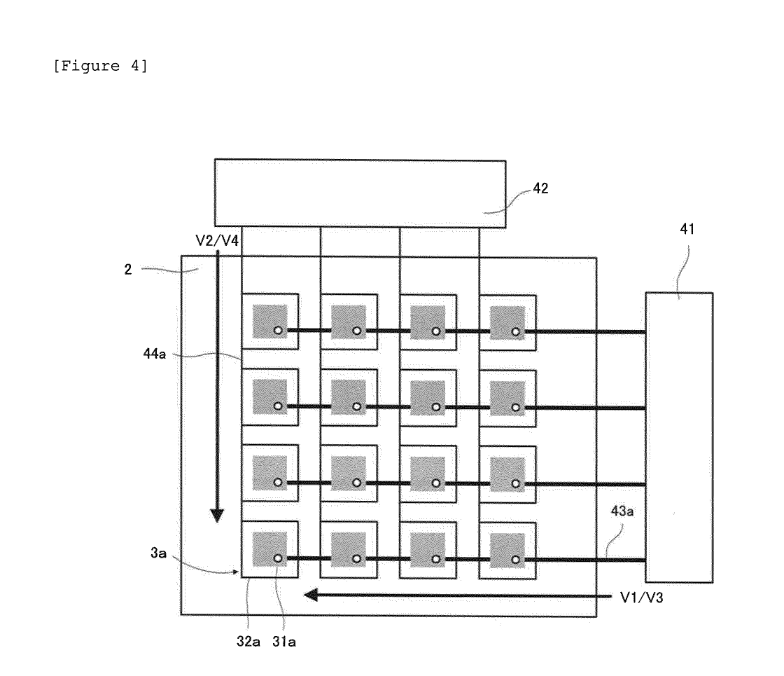

Next, the operation of the electrophoretic display device 1 configured as above is described with reference to FIGS. 3 and 4. FIG. 3 omits the lattice-like member 6 in the charged particle-containing chamber 5.

First, when a pixel Pa is displayed, as shown in FIG. 4, the X-axis drive circuit 41 applies a voltage V1 through an X-axis electrode wire 43a to a first electrode 31a of a pixel electrode unit 3a corresponding to the Pixel Pa. The thin-film transistor (not shown) of the first electrode 31a is thereby turned on, and the first electrode 31a is maintained at the voltage V1. Subsequently, the Y-axis drive circuit 42 applies a voltage V2, which is lower than the voltage V1, through a Y-axis electrode wire 44a to a second electrode 32a of the pixel electrode unit 3a. Thus, the first electrode 31a is positive, while the second electrode 32a is negative, so that the charged particles 51 are collected on the first electrode 31a. Accordingly, the pixel Pa displays the color of the charged particles 51 (FIG. 3 (a)). When the difference between the voltage V1 and the voltage V2 is reduced to lessen the amount of the charged particles 51 collected on the first electrode 31a, a mixed color (e.g., gray) of the color of the charged particles 51 and the color of the black plate or white plate is displayed.

Next, when the pixel Pa is not displayed, similar to the above case, the X-axis drive circuit 41 applies a voltage V3 to the first electrode 31a through the X-axis electrode wire 43a, and the Y-axis drive circuit 42 applies a voltage V4 to the second electrode 32a through the Y-axis electrode wire 44a (FIG. 4). In this case, the voltage V4 of the second electrode 32a is higher than the voltage V3 of the first electrode 31a, and the first electrode 31a is negative, while the second electrode 32a is positive, so that the charged particles 51 in the charged particle-containing chamber 8 are collected on the second electrode 32a (FIG. 3 (b)). Accordingly, the pixel Pa does not display the color of the charged particles 51, but displays the color of the black plate or white plate.

### Second Embodiment

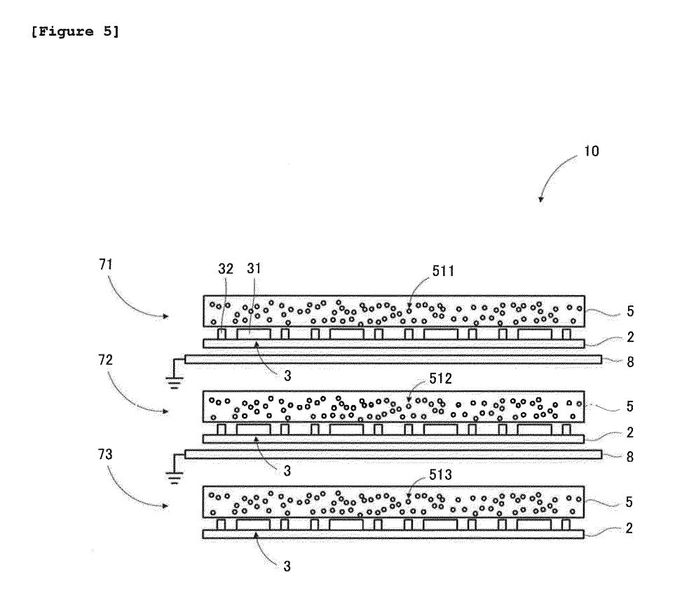

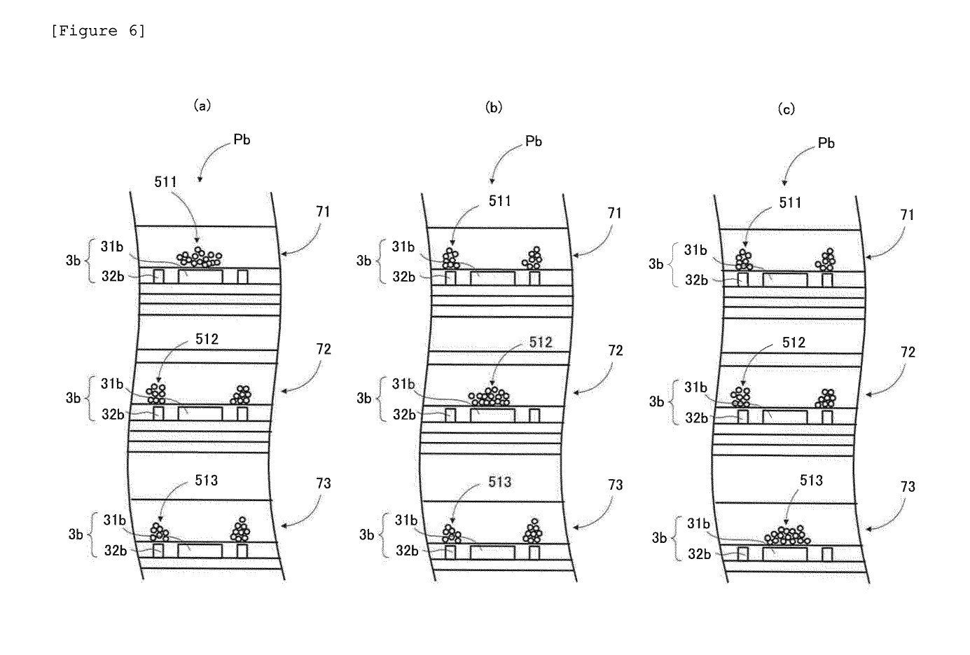

The second embodiment of the electrophoretic display device according to the present invention is described below with reference to FIGS. 5 and 6. In FIGS. 5 and 6, the same numbers are assigned to the same components as in the first embodiment, and the lattice-like member 6 in the charged particle-containing chamber 5 is omitted.

As shown in FIG. 5, an electrophoretic display device 10 according to the second embodiment has a structure in which first to third display units 71 to 73 are laminated. A charged particle-containing chamber 5 of the first display unit 71 contains green-colored charged particles 511, a charged particle-containing chamber 5 of the second display unit 72 contains red-colored charged particles 512, and a charged particle-containing chamber 5 of the third display unit 73 contains blue-colored charged particles 513. The color of the charged particles in the first display unit 71 to the third display units 73 may be, for example, cyan, magenta, or yellow. The order of the first display unit 71 to the third display units 73 may be suitably changed. Further, electric conductors 8, which are coated with an insulating material on their lower surface and are grounded, are each provided between the first display unit 71 and the second display unit 72, and between the second display unit 72 and the third display unit 73. This prevents the charged particles in each display unit from being affected by the pixel electrode unit 3 of the other display unit.

The electrophoretic display device 10 configured as above displays the colors of the charged particles 511 to 513 on the first to third display units 71 to 73 by controlling the polarity of the first electrodes 31 and the second electrodes 32, and causing the charged particles to be collected on the first electrodes 31 or the second electrodes 32 depending on the polarity, as in the first embodiment.

For example, when green is displayed on a pixel Pb, as shown in FIG. 6 (a), a voltage is applied to the first electrode 31b and the second electrode 32b in the first display unit 71 so that the first electrode 31b is positive, while the second electrode 32b is negative, thereby collecting the green charged particles 511 on the first electrode 31a. In contrast, in the second display unit 72 and the third display unit 73, a voltage is applied to the first electrodes 31b and the second electrodes 32b so that the first electrodes 31b are negative, while the second electrodes 32b are positive, thereby collecting the red charged particles 512 and the blue charged particles 513 on the second electrodes 32b. Accordingly, the pixel Pb displays green, which is the color of the charged particles 511 in the first display unit 71.

Similarly, when red is displayed on the pixel Pb, the red charged particles 512 in the second display unit 72 are collected on the first electrode 31b, while the green charged particles 511 in the first display unit 71 and the blue charged particles 513 in the third display unit 73 are collected on the second electrodes 32b (FIG. 6 (b)). To display blue on the pixel Pb, the blue charged particles 513 in the third display unit 73 are collected on the first electrode 31b, while the green charged particles 511 in the first display unit 71 and the red charged particles 512 in the second display unit 72 are collected on the second electrodes 32b (FIG. 6 (c)). When the charged particles in two or more display units are collected on the first electrodes 31a, a mixed color of two or more colors out of green, red, and blue is displayed on the pixel Pb. The amount of the charged particles collected on the first electrode 31b can be adjusted by changing the amount of voltage applied to the first electrode 31b and the second electrode 32b.

As described above, the electrophoretic display devices of the first and second embodiments are each configured so that the charged particles are filled in the charged particle-containing chamber 5, which is disposed along the substrate 2 provided with a plurality of pixel electrode units 3, thereby allowing the display of a plurality of pixels. This configuration facilitates the production of the electrophoretic display devices, without the need to produce a microcapsule for each pixel as in conventional types.

The embodiments of the present invention are described above; however, the present invention is not limited thereto, and various modifications can be made without deviating from the scope of the present invention. For example, in the above embodiments, the first electrode 31 and the second electrode 32 are formed on the same surface of the substrate 2, but may be formed on different surfaces of the substrate 2. In that case, it is preferable that the upper surface of the electric conductor 8 in the second embodiment also be coated with an insulating material.

In the above embodiments, the first electrode 31 has a square shape, but may have various shapes, including polygonal shapes other than square (e.g., triangular, rectangular, pentagonal, or hexagonal), and circular shapes.

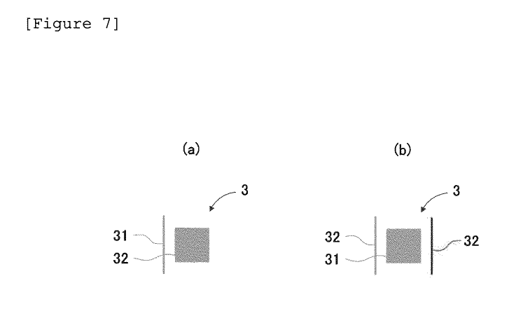

In the above embodiments, the second electrode 32 is disposed so as to surround the first electrode 31, but is not limited thereto insofar as the second electrode 32 is arranged on the peripheral edge of the pixel. For example, as shown in FIG. 7, one second electrode 32 may be arranged along only one side of the first electrode 31, or two second electrodes 32 may be arranged along opposite sides of the first electrode 31.

In the above embodiments, the substrate 2 is disposed below the charged particle-containing chamber 5, but may be located above or in the charged particle-containing chamber 5.

In the above embodiments, the charged particles are negatively charged electret particles, but may be particles that can be electrophoresed in the charged particle-containing chamber 5. The particles may be positively charged, or may not have electret properties.

### REFERENCE SIGNS LIST

1, 10: Electrophoretic display devices
2: Substrate
21: Through hole
3: Pixel electrode unit
31: First electrode
32: Second electrode
4: Voltage applying means
43: X-axis electrode wire (first wiring)
44: Y-axis electrode wire (second wiring)
5: Charged particle-containing chamber
6: Lattice-like member
71 to 73: Display units

1. An electrophoretic display device comprising at least three layers of display units with pixels, each display unit comprising:
a substrate;
a plurality of pixel electrode units formed for each pixel on the substrate;
a voltage applying means for applying a voltage to each pixel electrode unit;
a charged particle-containing chamber containing colored charged particles and disposed so as to extend across the plurality of pixel electrode units; and
a lattice-like member accommodated in the charged particle-containing chamber and extending across the plurality of pixel electrode units;
each of the pixel electrode units having a first electrode disposed in the center of a pixel, and a second electrode disposed on the peripheral edge of the pixel; and
the charged particles being colored with a different color for each charged particle-containing chamber.

2. An electrophoretic display device comprising at least three layers of display units with pixels, each display unit comprising:
a substrate;
a plurality of pixel electrode units formed for each pixel on the substrate;
a voltage applying means for applying a voltage to each pixel electrode unit; and
a charged particle-containing chamber containing colored charged particles and disposed so as to extend across the plurality of pixel electrode units;
each of the pixel electrode units having a first electrode disposed in the center of a pixel, and a second electrode disposed on the peripheral edge of the pixel; and
the charged particles being colored with a different color for each charged particle-containing chamber, and being negatively charged electret particles made of a material containing fluorine.

3. The electrophoretic display device according to claim 2, further comprising a lattice-like member that is accommodated in the charged particle-containing chamber and extends across the plurality of pixel electrode units.

4. The electrophoretic display device according to claim 1, wherein
the first electrodes and the second electrodes are disposed on one surface of the substrate; and
the voltage applying means has a first wiring formed on the other surface of the substrate and connected to each of the first electrodes via respective through-holes provided in the substrate, and a second wiring formed on the one surface of the substrate and connected to each of the second electrodes.

5. The electrophoretic display device according to claim 1, wherein
the first electrodes are disposed on one surface of the substrate;
the second electrodes are disposed on the other surface of the substrate; and
the voltage applying means has a first wiring formed on the one surface of the substrate and connected to each of the first electrodes, and a second wiring formed on the other surface of the substrate and connected to each of the second electrodes.

6. The electrophoretic display device according to claim 2, wherein
the first electrodes and the second electrodes are disposed on one surface of the substrate; and
the voltage applying means has a first wiring formed on the other surface of the substrate and connected to each of the first electrodes via respective through-holes provided in the substrate, and a second wiring formed on the one surface of the substrate and connected to each of the second electrodes.

7. The electrophoretic display device according to claim 3, wherein
the first electrodes and the second electrodes are disposed on one surface of the substrate; and
the voltage applying means has a first wiring formed on the other surface of the substrate and connected to each of the first electrodes via respective through-holes provided in the substrate, and a second wiring formed on the one surface of the substrate and connected to each of the second electrodes.

8. The electrophoretic display device according to claim 2, wherein
the first electrodes are disposed on one surface of the substrate;
the second electrodes are disposed on the other surface of the substrate; and
the voltage applying means has a first wiring formed on the one surface of the substrate and connected to each of the first electrodes, and a second wiring formed on the other surface of the substrate and connected to each of the second electrodes.

9. The electrophoretic display device according to claim 3, wherein
the first electrodes are disposed on one surface of the substrate;
the second electrodes are disposed on the other surface of the substrate; and
the voltage applying means has a first wiring formed on the one surface of the substrate and connected to each of the first electrodes, and a second wiring formed on the other surface of the substrate and connected to each of the second electrodes.
